(19) United States
(12) Patent Application Publication
(10) Pub. No.: US 2014/0000476 A1
(43) Pub. Date: Jan. 2, 2014

(54) HYDROPHOBIC AND LIPOPHOBIC COMPOSITION COMPRISING COMPOUNDS HAVING A BISPHOSPHONIC AND THIOL GROUP

(71) Applicants: David Portet, Briollay (FR); Gregory Lecollinet, Juvardeil (FR)

(72) Inventors: David Portet, Briollay (FR); Gregory Lecollinet, Juvardeil (FR)

(73) Assignee: SURFACTIS TECHNOLOGIES, Angers (FR)

(21) Appl. No.: 13/997,003

(22) PCT Filed: Dec. 21, 2011
(86) PCT No.: PCT/EP2011/073661

§ 371 Date: Sep. 13, 2013

(30) Foreign Application Priority Data
Dec. 23, 2010 (FR) 1061202

(51) Int. Cl. C09D 7/12

(52) U.S. Cl. CPC C09D 7/1233
USPC 106/2; 427/314; 427/318; 427/58; 438/758

(57) ABSTRACT

The present invention describes the highly advantageous properties of a mixture of thiol-perfluoropolyether (PFPE) molecules with perfluorinated bisphosphonic compounds (BP-PF). This mixture in fact makes it possible to obtain a lipophobic and hydrophobic behaviour on numerous materials, including metals, inter alia gold and alloys thereof. It makes it possible to prevent corrosion, and to limit deposition of soiling and microbiological contamination on these surfaces, while at the same time conferring good mechanical strength and resistance to ageing and to cleaning products. It also makes it possible to lubricate the metal parts that it covers.

The present invention describes the highly advantageous properties of a mixture of thiol-perfluoropolyether (PFPE) molecules with perfluorinated bisphosphonic (PF-BP) compounds. As a matter of fact, this mixture enables to obtain lipophobic and hydrophobic behaviour in all the materials tested, including metals, among others gold and alloys thereof. It helps prevent corrosion and limits dirt deposits and microbial contamination on its surfaces, at the same time as conferring good mechanical resistance, resistance to ageing and to cleaning products. It also enables to lubricate metal pieces coated with it.

### PRIOR ART

The metal surfaces which are occasionally or frequently in contact with fingers, for example bottles and/or their stoppers, pens, belts, tinted glasses or even compounds used in microtechnology and microelectronics, are subject to various types of contamination. The handling of these objects, the products that contain them or contact with ambient air can lead, under certain conditions, dirt deposits and/or microbial contamination (fungi, bacteria, viruses, etc.), which can be very problematic when the content of the bottle (cream, oil, perfume, drug, etc.) is administered to the skin or swallowed by the user. Moreover, the presence of these unsightly marks can also be problematic when marketing these objects.

It is well known that fingerprints are the origin of many of these marks. The substances responsible for these prints (greasy or aqueous substances) can originate either from external contamination (transfer of dirt) or is secreted by the skin (for example from sweat which has a lipid and aqueous composition).

Dirt (finger marks, contamination, etc.) can be cleaned using a cleaning agent (wipes, soap, etc.) but this is temporary measure and has to be repeated frequently.

A good means for lasting and effective prevention of the deposit of such contaminants would be to treat the surfaces to render them hydrophobic and lipophobic. In effect, this permanent treatment would prevent lipophilic (fats, sweat, wax, etc.) and hydrophilic (water, sweat, dew, etc.) compounds from being deposited on the surfaces and that the microorganisms that are suspended herein can fix same.

Surface coatings that limit contamination and/or dirt deposits have already been described, in particular those based on organic compounds comprising carboxylic acid or a phosphonic acid (WO2007/112312), or based on organophosphorous acid (EP 1955638).

Nevertheless, these techniques were not satisfactory insofar as they did not make it possible to treat all metal surfaces efficaciously (especially gold and silver)

This is why the present Inventors sought to identify a surface functionalisation method to permanently increase the hydrophobic and lipophobic nature of surfaces consisting of whatever metal, such that corrosion and/or dirt deposits on these surfaces are permanently and effectively reduced. This functionalisation layer must be resistant to high temperatures as it may subsequently undergo high-temperature treatment and multiple washes.

The Inventors firstly focused on thiol molecules having the general formula H(CH₂)ₙSH which can form self-assembled layers on gold (Bain C. D. et al, J. Am. Chem. Soc 1989). The sulphur atoms bind to the metal surface while the alkyl chains point to the other side, aligning and arranging in an even geometric pattern on the surface (leading to the formation of “self-assembled” mono layers). These monolayers have alkyl molecules on their surface which confer a degree of hydrophobicity. However, a major drawback to the use of such molecules is their unpleasant odour. Moreover, the self-assembled layers consisting of perfluoroalkyl thiols often have low temperature resistance and low resistance to oxidising and reducing products (C. Shi et al, J. Supercriti. Fluids 2000).

Moreover, it is known that bisphosphonate compounds, especially bisphosphonic compounds with a perfluorinated group (BP-PF) or perfluoropolyether (BP-PFPE), modify wetting properties and make the surfaces they cover hydrophobic and lipophobic (FR 2904784 and EP 2054165). The solvents used to deposit these molecules are conventional industrial organic solvents such as alcohol solvents, aldehydes, ketones, ethers, etc. These compounds are capable of binding as self-assembled mono-layers to metallic materials such as iron, titanium, copper, aluminium, nickel, tin or to metal alloys (for example steel, stainless steel, brass, nickel silver, bronze, tin-nickel, nickel-phosphorus, copper-beryllium).

However, the affinity of phosphonic groups varies from one metal or mineral surface to another as well as for various oxides or alloys is limited (Folkers et al, Langmuir (1995) 11, 813-824). In addition, due to their low degree of oxidation, gold and silver are not compatible with solid binding of the layers of PF and PFPE bisphosphonic compounds. However, the materials considered in this invention can consist of these metals, and it is therefore important that the composition of the invention can be used to functionalise surfaces comprised of any metal whatsoever, including gold and silver.

In addition, the functionalisation of surfaces with fluorinated polymers, where this is possible, has the major disadvantage of requiring the use of perfluorinated solvents whose use is controlled by extremely strict regulations and is therefore problematic.

The Inventors have discovered that coating a metal surface with a composition comprising both perfluoropolyether-thiol molecules (thiols-PFPE) and BP-PFPE molecules in a non-fluorinated organic solvent increases its lipophobicity and its hydrophobicity, such that corrosion and/or dirt deposits and/or microbial contamination of this surface are reduced permanently and effectively. This coating also reduces the surface energy of these surfaces and confers lubricating properties on these surfaces. Importantly, these surfaces can consist of any metal whatsoever.

The strong bond between thiol-PFPE molecules and BP-PFPE molecules in coated surfaces makes it possible to avoid the user or product in contact with these surfaces being contaminated by these molecules.

### SUMMARY OF THE INVENTION

A first aspect of the invention concerns a composition comprising at least one thiol compound and at least one bisphosphonic compound or salts thereof, characterised in that said thiol compound has the formula:

HS-A-B-C

### Wherein

A is a (CH₂)ₘ—X— group, m being an integer between 0 and 100, and X being a saturated or unsaturated C₀-C₁₀₀ alkyl group, perfluorinated or partially fluorinated, the alkyl chain possibly being substituted or interrupted by 0 to 10 cycloalkyl or aryl groups that may be perfluorinated or not;

B is

a) a single chemical bond, or an O, S atom or an
S(CO),(CO)S or NR, (CO)NR, NR(CO) group, R being a hydrogen atom or a C₁-C₁₀ alkyl, or

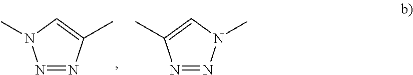

and

C is chosen from among: F(CF(CF₃)CF₂O)ₙCF(CF₃)—,
F(CF₂CF(CF₃)O)ₙCF₂CF₂—, F(CF₂CF₂CF₂O)ₙCF₂CF₂—, and F(CF₂CF₂O)ₙCF₂—,

and CₚF₂ₚ₊₁—, wherein n and p are integers between 1 and 100,

and characterised in that said bisphosphonic compound has the formula:

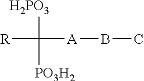

### Wherein

R is a hydrogen atom H or an OH group,

A is a (CH₂)ₘ—X group, m being an integer between 0 and 100, and X being a saturated or unsaturated C₀-C₁₀₀ alkyl group, perfluorinated or partially fluorinated, the alkyl chain possibly being substituted or interrupted by 0 to 10 cycloalkyl or aryl groups that may be perfluorinated or not;

B is

a) a single chemical bond, or an O, S atom or an
S(CO),(CO)S or NR, (CO)NR, NR(CO) group, R being a hydrogen atom or a C₁-C₁₀ alkyl, or

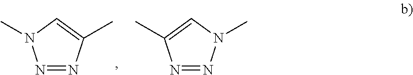

and

C is chosen from among: (CF(CF₃)CF₂O)ₙCF(CF₃)—, F(CF₂CF(CF₃)O)ₙCF₂CF₂—, F(CF₂CF₂CF₂O)ₙCF₂CF₂—, F(CF₂CF₂O)ₙCF₂ and CₚF₂ₚ₊₁—, wherein n and p are integers between 1 and 100.

Preferably, said thiol compound is a perfluorinated thiol of the following formula I:

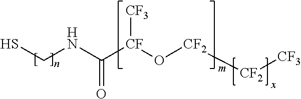

wherein n is an integer from 1 to 100, m is an integer from 1 to 100 and x is an integer between 1 and 10, and said bisphosphonic compound is a perfluorinated bisphosphonic of following formula II:

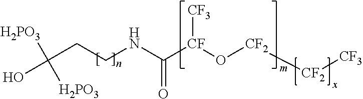

wherein n is an integer between 1 and 100, m is an integer between 1 and 100, and x is an integer between 1 and 10.

Even more preferably, said perfluorinated thiol compound is a compound of formula I wherein n=6, m=4, and x=1, or n=2, m=4 and x=1, or n=6, m=5 and x=1, or n=2, m=5 and x=1, and said perfluorinated bisphosphonic compound is a compound of formula II wherein n=4, m=4, and x=1.

In a particular embodiment of the invention, said bisphosphonic compounds and said thiol compounds are dissolved in water or in an organic solvent chosen from alcohol solvents, especially C₁ to C₆ alcohols such as isopropanol, ethanol, methanol, aldehydes, ketones such as acetone, ethers such as diethyl ether or tetrahydrofuran or alkanes, in particular C₁ to C₈ alkanes as well as mixtures thereof, or in a solvent consisting of hydrated naphthas in mixture with, for example IPA or acetone.

This composition makes it possible to limit the corrosion of surfaces it covers, and reduces dirt deposits and/or microbial contamination of such surfaces.

In a second aspect, the present invention also covers the use of such a composition to increase the hydrophobicity and lipophobicity of a surface, the use of such a composition to limit corrosion of the surface and the use of such a composition to limit dirt deposits and/or microbial contamination of a surface. Preferably, said surface is metallic.

In another aspect, these compositions can be used to reduce the surface energy of treated surfaces and therefore to lubricate metal parts by reducing their friction coefficient and limiting the mechanical wear and tear.

These surfaces can be used in bottles, in particular in the fields of pharmaceuticals, cosmetics, perfumery, or in jewelry or other luxury items, or in parts used in microtechnology and microelectronics (optics, lenses, telephone chips, micromotors, microclamps, pacemakers, etc.).

These metal surfaces can consist of over 50% of:
noble metals selected from gold, platinum, silver and copper,
oxidised metals selected among iron, titanium, aluminium, ruby, sapphire, nickel, ruthenium, rhodium and tin,
alloys selected from steel, stainless steel, brass, nickel-silver, bronze, tin-nickel, nickel-phosphorus, copper-beryllium, palladium-nickel, copper-cobalt, or alloys containing vanadium, chromium, manganese, zinc, tungsten or zirconium, or another amorphous alloy, or
ceramics, or
semi-conductors such as silicon or germanium and their oxides, or even diamond.

In a third aspect, the present invention covers a method for coating a surface, preferably a metal surface, a molecular functionalisation layer, characterised in that it comprises at least the following steps:
a) Optionally degreasing the surface by washing with a solvent and then drying,
b) Optionally oxidising the surface so as to create hydroxyl groups at the surface of the substrate,
c) Contacting the surface with the composition of the invention, up to the point of self-assembly of thiol and/or bisphosphonic compounds in a single layer coating said surface,
d) Removing the supernatant,
e) Optionally dehydrating the surface thus coated,
f) Rinsing the functionalised surface,
g) Drying the functionalised surface.

In a fourth aspect, the present invention covers the use of a functionalised surface obtained from the previously defined process for the manufacture of bottles, containers, mechanical parts or finishes intended for use in cosmetics, pharmaceuticals, in a luxury and/or perfumery product, or even in the field of microtechnology and microelectronics.

Finally, the present invention covers the use, to increase the hydrophobicity and lipophobicity of a surface, to limit the corrosion of a surface, or to limit dirt deposits and/or microbial contamination of a surface, of a composition containing the thiol compound of formula I.3 (as the sole active agent):

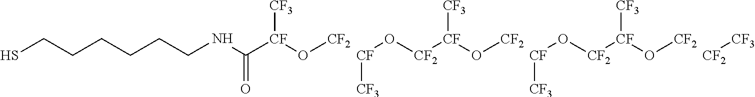

In a particular embodiment, said surface is a metal surface comprised of more than 50% of a noble metal selected from gold, silver, copper and the compound of formula I.3 is dissolved in isopropanol or in a solvent consisting of hydrotreated naphthas.

### KEY TO THE FIGURES

FIG. 1 shows the PF-thiol (I.5) and PFPE-thiols (I.1 to I.4 and I.6) compounds of formula I according to the invention.

FIG. 2 shows examples of BP-PF and BP-PFPE molecules of formula II according to the invention.

### DETAILED DESCRIPTION OF THE INVENTION

The present Inventors have demonstrated that a coating composition comprising i) thiol compounds, mixed with ii) bisphosphonic compounds can cover a large number of metal surfaces, including those made of gold, silver or their alloys, and reduces the corrosion of these surfaces, as well as dirt deposits, very effectively and permanently.

As a matter of fact, the monolayers formed as a result of coating the surfaces with the composition of the invention confer a hydrophobic and lipophobic nature on these surfaces which limits the adhesion of droplets of water, sweat and/or oily substances and therefore prolonged contact with the microorganisms they contain. Advantageously, the coating composition does not include a fluorinated solvent.

In a first aspect, the present invention relates to the use of a coating composition, called the “coating composition of the invention”, comprising at least one thiol compound and at least one bisphosphonic compound, or one of their salts.

The thiol compounds present in the coating composition of the present invention have the formula:

HS-A-B-C

### Wherein

A is a (CH₂)ₘ—X— group, m being an integer between 0 and 100, and X being a saturated or unsaturated C₀-C₁₀₀ alkyl group, perfluorinated or partially fluorinated, the alkyl chain possibly being substituted or interrupted by 0 to 10 cycloalkyl or aryl groups that may be perfluorinated or not;

B is

a) a single chemical bond, or an O, S atom or an S(CO),(CO)S or NR, (CO)NR, NR(CO) group, R being a hydrogen atom or C₁-C₁₀ alkyl, or

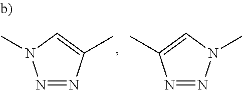

and

C is chosen from among: F(CF(CF₃)CF₂O)ₙCF(CF₃)—,

F(CF₂CF(CF₃)O)ₙCF₂CF₂—, F(CF₂CF₂CF₂O)ₙCF₂CF₂—, and F(CF₂CF₂O)ₙCF₂—, and

CₚF₂ₚ₊₁—, wherein n and p are integers between 1 and 100.

Moreover, said bisphosphonic compound present in the coating composition of the present invention has the formula:

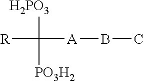

### Wherein

R is a hydrogen atom H or an OH group,

A is a (CH₂)ₘ—X— group, m being an integer between 0 and 100, and X being a saturated or unsaturated C₀-C₁₀₀ alkyl group, perfluorinated or partially fluorinated, the alkyl chain possibly being substituted or interrupted by 0 to 10 cycloalkyl or aryl groups that may be perfluorinated or not;

B is

a) a single chemical bond, or an O, S atom or an S(CO),(CO)S or NR, (CO)NR, NR(CO) group, R being a hydrogen atom or C₁-C₁₀ alkyl, or

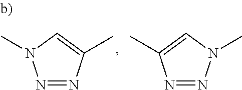

and

C is chosen from among: (CF(CF₃)CF₂O)ₙCF(CF₃)—,

F(CF₂CF(CF₃)O)ₙCF₂CF₂—, F(CF₂CF₂CF₂O)ₙCF₂CF₂—, F(CF₂CF₂O)ₙCF₂ and CₚF₂ₚ₊₁—, wherein n and p are integers between 1 and 100.

By “C₀-C₁₀₀ alkyl” group, we mean, in terms of the present invention, a saturated, linear or branched divalent hydrocarbon chain comprising 0 to 100, preferably 1 to 10, carbon atoms. Examples of this are methylene, ethylene, propylene, isopropylene, butylene, isobutylene, sec-butylene, pentylene or even hexylene groups.

By “perfluorinated”, we mean a molecule substituted by at least one CF₃(CF₂)ₙ group, n preferably being between 0 and 50, even more preferably between 0 and 10.

By “partially fluorinated”, we mean a molecule whose carbon atoms are at least partially substituted by fluorine atoms.

By “cycloalkyl” group, we mean, in terms of the present invention, a cyclic saturated hydrocarbon chain, preferably including between 3 and 7 cyclic carbon atoms. An example of this is cyclopropyl, cyclopentyl, cyclohexyl and cycloheptyl groups.

By “aryl”, we mean, in terms of the present invention, an aromatic group, preferably including 6 to 10 carbon atoms, and including one or more attached rings, such as for example the phenyl or naphthyl group. Advantageously this is a phenyl.

The possible salts include, in particular, sodium or potassium salts, calcium or magnesium salts, or salts formed by appropriate organic ligands such as quaternary ammonium salts. The salts are therefore preferably chosen from sodium, potassium, magnesium, calcium and ammonium salts.

Preferably, the thiol compound present in the coating composition of the invention is a perfluorinated thiol of following formula I:

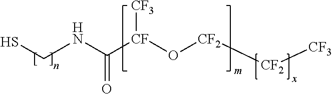

wherein n is an integer between 1 and 100, m is an integer between 1 and 100 and x is an integer between 1 and 10, or a salt thereof, preferably a potassium, sodium, magnesium, calcium or ammonium salt.

Preferably, n is between 1 and 20, and even more preferably between 1 and 10; preferably, m is between 1 and 20 and even more preferably between 1 and 10; preferably x is between 1 and 5 and even more preferably x is equal to 1.

Preferably, the bisphosphonic compound present in the coating composition of the invention is a perfluorinated bisphosphonic of following formula II:

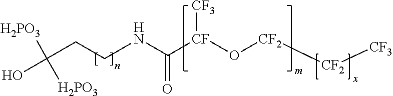

wherein n is an integer between 1 and 100, m is an integer between 1 and 100 and x is an integer between 1 and 10, or a salt thereof, preferably a potassium, sodium, magnesium, calcium or ammonium salt.

Preferably, n is between 1 and 20, and even more preferably between 1 and 10; preferably, in is between 1 and 20 and even more preferably between 1 and 10; preferably x is between 1 and 5 and even more preferably x is equal to 1.

According to a preferred embodiment, the bisphosphonates present in the coating composition of the invention therefore carry a perfluorinated group (BP-PF) or perfluoropolyether (BP-PFPE) such as described in patent application No. FR2904784 and EP 2 054 165. As a result of the multiplicity of phosphonate groups (—PO₃H₂), these molecules are capable of permanently grafting onto mineral or metal surfaces in the form of self-assembled monolayers. Physicochemical characterisation of the monolayer obtained from these molecules is described in detail in the article of Lecollinet et al. (Langmuir, 2009). The bisphosphonate molecules bind in the form of self-assembled monolayers to metal or mineral materials, preferably oxides such as iron, titanium, copper, aluminium, nickel, tin or metal alloy (e.g. steel, stainless steel, brass, nickel-silver, bronze, tin-nickel, nickel-phosphorus, copper-beryllium). Reducing the surface energy of the treated material is then important (surface energy <20 mJ/m²).

Preferably the coating composition of the invention is used to limit the corrosion of the surfaces it covers in order to reduce dirt deposits and/or microbial contamination on these. Said surface is preferably metallic.

The coating composition can be liquid, gaseous or supercritical. When it is liquid, the coating composition of the invention can be an aqueous or organic composition. The liquid composition solvent is selected to allow the two types of compound present in the composition to be dissolved. This organic solvent can be chosen from alcohol solvents, in particular C₁ to C₆ alcohol such as isopropanol, ethanol, methanol, aldehydes, ketones such as acetone, ethers such as diethylether or tetrahydrofuran or alkanes, notably C₁ to C₈ alkanes as well as mixtures thereof. The composition can be a gas, BP compounds and thiols can notably be in the vapour state. “Supercritical composition” refers to a composition which is found in a supercritical fluid state.

The coating composition of the invention is advantageously in the form of a solution, a suspension, an emulsion, a supercritical fluid, an aerosol or a foam. Content in bisphosphonic compounds in the liquid coating composition is preferably between 0.0001 and 20% by weight, preferably between 0.001 and 5% by weight, and the content in thiol compounds in the liquid coating composition is preferably between 0.0001 to 20% by weight, preferably between 0.001 and 5% by weight.

According to one embodiment, the thiol compounds and BP are incorporated into the coating composition of the invention at a molar concentration of between 10⁻¹ and 10⁻¹⁵ mol/L of each compound, preferably between 10⁻³ and 10⁻⁵ mol/L. Advantageously the two compounds, thiol and bisphosphonate, have the same concentration.

In a preferred embodiment, the coated metal surface is composed of more than 50%, preferably more than 75%, even more preferably 85%:
noble metals selected from gold (Au), platinum (Pt), silver (Ag) and copper (Cu),
oxidised metals selected from iron (Fe), titanium (Ti), aluminium (Al), rubies (aluminium and chromium oxide alloy, CAS no. 12174-49-1), sapphire (aluminium oxide, CAS no. 1317-82-4) nickel (Ni), ruthenium (Ru), rhodium (Rh), and tin (Sn),
alloys selected from steel (alloy or iron and carbon), stainless steel, brass (an alloy of copper and zinc), nickel-silver (an alloy of copper, nickel and zinc), bronze (an alloy of copper and tin), tin-nickel (Sn—Ni), nickel-phosphorus (Ni—P), copper-beryllium (Cu—Be), palladium-nickel (Pd—Ni), copper-cobalt (Cu—Co), or alloys comprising vanadium (V), chromium (Cr), manganese (Mn), zinc (Zn), tungsten (W), or zirconium (Zr), or an amorphous alloy, or
ceramics, or
semi-conductors such as silicon (Si) or germanium (Ge) as well as oxides thereof, or even diamond.

In the context of the present invention, an alloy is called “amorphous” when atoms do not follow any medium and long distance order (contrary to crystallized compounds). Glass is an amorphous compound.

In the context of the present invention, ceramics are crystalline or partly crystalline structures, or of glass, and formed essentially of inorganic and non-metallic substances, by a melting mass which solidifies on cooling, or which is formed and brought to maturity simultaneously or subsequently through the effect of heat. This may include oxide ceramics (oxides of aluminium, zirconium), non-oxide ceramics (carbides, borides, nitrides, ceramics composed of silicon and carbon such as tungsten, magnesium, platinum or titanium), or finally ceramic composites (combination of oxides and non-oxides such as rubies).

Preferably, the coating composition of the invention contains a perfluorinated thiol compound of formula I such as that defined above, and a perfluorinated bisphosphonic compound of formula II such as that defined above.

Even more preferably, the composition of the invention contains a perfluorinated thiol compound of formula I wherein n=6, m=4, and x=1, or n=2, m=4 and x=1, or n=6, m=5 and x=1, or n=10, m=5, and x=1 or n=2, m=5 and x=1, and a perfluorinated bisphosphonic compound of formula II wherein n=4, m=4 and x=1 or n=8, m=5, and x=1.

Most preferably of all, the composition of the invention contains a perfluoropolyether thiol compound of formula I wherein n=6, m=5 and x=1, and a perfluorinated bisphosphonic compound of formula II wherein n=4, m=4 and x=1.

The solvent of the liquid coating composition of the invention is selected so as to allow solubilisation of the two types of compounds it contains. This solvent may be selected from alcohol solvents, especially C₁ to C₆ alcohols such as isopropanol, ethanol, methanol, aldehyde, ketones such as acetone, ethers such as diethylether or tetrahydrofuran or alkanes, particularly C₁ to C₈ alkanes as well as mixtures thereof. Even more preferably, the solvent is isopropyl alcohol (IPA) (or isopropanol), or a solvent consisting of hydrotreated naphthas in mixture with, for example, IPA or acetone.

In a second aspect, the present invention relates to the use of such a composition to increase the hydrophobicity and/or lipophobicity of a surface, preferably of a metal surface.

These advantageous properties are used to limit dirt and mould deposits and/or microbial contamination of these surfaces.

The composition of the invention can also be used advantageously to limit the corrosion of these surfaces.

These compositions can also be used to reduce the surface energy of treated surfaces. As described in applications FR 2904784 and EP 2054165, the use of layers with low surface energy is common in the field of lubrication of mechanical parts. This notion of lubrication, in practice, covers a very large number of physical phenomena, such as surface adhesion (due to surface bumps but also to the surface energies of the materials in question), sliding of surface layers, “surfing” on the more or less viscous liquid (“hydrodynamic” lubrication). Within the context of the lubrication of metal parts, it is desirable to very strongly bound layers which result in low surface energy surfaces. Consequently the use of a thiol-bisphosphonate mixture that both binds strongly to the support materials and has a perfluorinated or perfluoropolyether group means that dry lubrication of these materials can be carried out.

In a third aspect, the composition of the invention can thus be used to lubricate a metal surface (surface of a metal part or of a part coated with a metal layer) by reducing the friction coefficient and limiting mechanical wear and tear of parts protected in this way.

In a fourth aspect, the present invention relates to a method for coating a surface, preferably a metal surface, with a molecular functionalisation layer, characterised in that it comprises at least the following steps:
a) optionally degreasing the potential surface by washing with a solvent and then drying,
b) optionally oxidising the surface so as to create hydroxyl groups at the surface of the substrate,
c) contacting the surface with the composition of the invention, up to the point of self-assembly of thiol and/or bisphosphonic compounds in a single layer covering said surface,
d) removing the supernatant,
e) optionally dehydrating the surface thus coated,
f) rinsing the functionalised surface,
g) drying the functionalised surface, preferably with heat.

Preferably, the surfaces coated by this method are used in bottles and/or stoppers intended for the pharmaceutical, cosmetics and/or perfume industries, in jewelry or other luxury items, in parts used in microtechnology (telephone chips, microclamps, pacemakers, micromotors, etc.) or any other object coated with a metal surface potentially in contact with the fingers, air or a liquid that needs to be protected (door handles, belts, glasses, pens, scissors, etc.)

In the context of the present invention, by “micromechanics”, we mean the set of techniques used from the design to the manufacture (then repair) of small-sized objects. Microtechnology includes apparatuses and machines which acquire, process and render information. They concern the following products and activities: office automation, data processing, instruments and metrology, control devices (signal amplifiers, remote control, remote measurement), telecommunications devices, consumer electronics, technical games, electronic banking, optical devices, electrical household equipment, industrial production equipment, medical instrumentation, or even small-sized components (relays, engines, microswitches, sensors, electrical outlets). The microtechnology scale ranges from a micrometer (μm, or 10⁻⁶ metre) to a millimetre.

In the context of the present invention, by “molecular functionalisation layer”, we mean a layer consisting of molecules which are each anchored to the substrate by at least one of their endings and arranged adjacent to each other. The molecules are anchored to the substrate preferably by thiols or bisphosphonic endings and are not linked to each other covalently. Their surface organisation and the different chemical groups they carry make it possible to modify the chemical and physical properties of surfaces coated in this way. The thickness of the molecular layer obtained by the method of the present invention is preferably in the nanometre range, in other words between 0.1 nm and 50 nm.

By “hydroxyl substrate”, we mean a substrate whose surface has —OH functions as well as X—OH functions (X being a component element of the surface). The more —OH groups the substrate surface presents, the greater the density of the gem-bisphosphonic compounds attached to this surface will be.

It is possible to use pre-oxidation of the surface of the substrates so as to achieve a sufficient number of hydroxyl groups on the surface of the substrate (step b). In practice, preliminary oxidation of the surface of the substrate is carried out so as to have a sufficient number of hydroxyl groups on the surface of the substrate to allow binding of bisphosphonic compounds, when said substrate has none of them or substantially few. It can also be carried out when it is desirable to increase the number of hydroxyl groups already present in order to obtain greater surface coverage by the bisphosphonic compounds. For example, it is advantageous to carry out this oxidation step on a surface comprising essentially of silicon.

According to the method of the present invention, the surface is contacted with a liquid coating composition containing BP and thiols until self-assembly of said compounds takes place into a layer covering said surface (step c). Typically, the duration of contact of the composition on the surface to be treated is between 10 seconds and 6 hours, preferably between 1 minute and 1 hour, even more preferably between 3 minutes and 30 minutes. Contacting the liquid coating composition with the substrate surface is advantageously carried out by soaking, spin coating, wiping, spraying, aerosol or spray. When the coating composition is gaseous or supercritical, contact with the substrate surface can be carried out using a reactor whose pressure and temperature are controllable and which allows injection of a gas such as CO₂.

After the step contacting the surface with the coating composition, elimination of the coating composition is carried out (step d) in order to eliminate the solvent and all thiol and bisphosphonic compounds from the surface which did not bind to the substrate in the course of contacting. Elimination of the coating composition can be carried out by rinsing or mechanically by draining, centrifugation or evaporation. The surface can moreover be rinsed, in particular by immersion in an appropriate solvent in order to carry out complete elimination of the non-bound solution. Said appropriate solvent is preferably the one used to prepare the solution.

The method of the present invention allows covalent type grafting of BP and/or thiols to oxidised metallic or ceramic surfaces (step e), possibly using dehydration techniques by heating whether under reduced pressure or not which allow transformation of an electrostatic interaction into a P—O—X type covalent bond (X being a constituent element of the surface). It is advantageous to carry out this dehydration step on rubies, silicon or titanium for example.

Advantageously, when required, the surface dehydration step is carried out thermally, preferably under reduced pressure, in particular by means of a lyophiliser. More particularly, dehydration of the substrate surface can be carried out by heating it at a temperature between 20° C. and 150° C., preferably at about 50° C. under pressure between 0.01 mBar and 1 Bar, preferably at 0.3 mBar, for a period of time between 1 and 72 hours, preferably for around 15 hours. It is also possible to dehydrate the surface at atmospheric pressure for 15 hours at 120° C.

The surface is rinsed (step f), in particular by immersion in an appropriate solvent in order to ensure complete elimination of non-bound solution. This step can be carried out using ultrasound. Said appropriate solvent is preferably that used to prepare the solution.

Steps e) and f) can be reversed, with rinsing taking place before dehydration of the coated surface.

The surface can be dried (step g) under hot air, for example at 70° C. for 2 minutes.

Steps c) to f) of the coating method of the invention can be repeated which improves the efficacy of coating.

The method of the present invention makes it possible to coat metallic surfaces consisting of over 50%, preferably over 75%, even more preferably of 85%:
noble metals selected from gold (Au), platinum (Pt), silver (Ag) and copper (Cu),
oxidised metals selected from iron (Fe), titanium (Ti), aluminium (Al), rubies (aluminium and chromium oxide alloy, CAS no. 12174-49-1), sapphire (aluminium oxide, CAS no. 1317-82-4) nickel (Ni), ruthenium (Ru), rhodium (Rh), and tin (Sn),
alloys selected from steel (iron and carbon alloy), stainless steel, brass (an alloy of copper and zinc alloy), nickel-silver (an alloy of copper, nickel and zinc), bronze (an alloy of copper and tin alloy), tin-nickel (Sn—Ni), nickel-phosphorus (Ni—P), copper-beryllium (Cu—Be), palladium-nickel (Pd—Ni), copper-cobalt (Cu—Co), or alloys comprising vanadium (V), chromium (Cr), manganese (Mn), zinc (Zn), tungsten (W), or zirconium (Zr), or an amorphous alloy, or
ceramics, or
semi-conductors such as silicon (Si) or germanium (Ge) as well as oxides thereof, or even diamond.

Finally, in a fifth aspect, the present invention concerns the use of a functionalised surface by means of the method of the invention for the manufacture of bottles and/or stoppers intended for the pharmaceutical, cosmetics and/or perfume industries, in jewelry or other luxury items, or in parts used in microtechnology and microelectronics or any other object coated with a metal surface and sensitive to fingerprints protected (for example door handles, pens, belts, tinted glasses, etc.)

The present invention also describes compositions comprising an effective amount of thiols and bisphosphonic compounds, preferably of formula (I) and (II), or their toxicologically acceptable salts, capable of binding permanently to metal surface intended for bottle making or coating any object potentially in contact with the fingers, air or a liquid of whatever sort, and capable of increasing the lipophobicity and/or hydrophobicity and therefore capable of limiting the deposits, and thus microbial contamination, of these surfaces.

These compositions are also capable of reducing the corrosion of these surfaces or of lubricating them.

More particularly, the composition of the invention makes it possible to obtain contact angle between the oil and the coated surface of at least 30°, and an angle between water and the coated surface of at least 90°.

By the term “effective amount”, we mean that the amount of compound applied makes it possible, after coating, to form a monomolecular making it possible to obtain the above-mentioned angles.

In a last aspect, the present invention relates to a coating composition comprising at least one thiol compound of formula I wherein n=6, m=5 and x=1, that is formula I.3.:

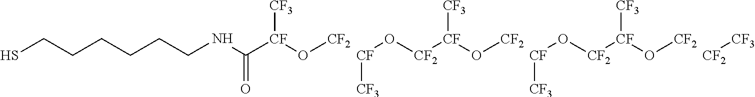

or a salt thereof, preferably a potassium, sodium, magnesium, calcium or ammonium salt.

The present Inventors have in fact discovered that this particular molecule is more effective than other molecules of formula I in increasing the lipophobic and hydrophobic effect (see example 9 below). In addition to these characteristics, this molecule is soluble in many solvents and solvent mixtures. Once deposited on the metal surfaces, the layers formed by these molecules show considerable resistance to washing.

The present invention therefore also concerns the use of a composition containing, as the only coating active ingredient, the thiol compound of formula I.3:

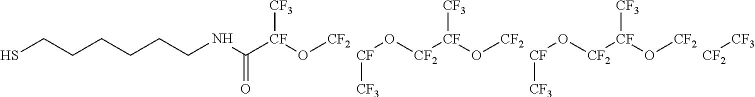

to increase the hydrophobicity and lipophobicity of a surface, or to limit corrosion of a surface and/or reduce dirt deposits and/or microbial contamination of such a surface, said surface preferably being used in bottles and/or their stoppers, for example intended for the pharmaceutical, cosmetics and/or perfume industries, in jewelry or other luxury items, or in parts used in micromechanics, microtechnology and microelectronics, or any other object potentially in contact with the fingers (glasses, pens, belts, etc.).

Preferably, said surface is metallic and contains more than 50% gold, silver or copper.

This composition can also be used to lubricate metal parts or parts coated with a metal surface.

This coating composition can be an aqueous or organic composition comprising an organic solvent selected from alcohol solvents, especially C₁ to C₆ alcohols such as isopropanol, ethanol, methanol, aldehydes, ketones such as acetone, ethers such as diethylether or tetrahydrofuran or alkanes, notably C₁ to C₈ alkanes as well as mixtures thereof. The solvent can also consist of hydrotreated naphthas (for example the solvent Biosane T212 by MMCC) mixed with IPA or acetone. Preferably the solvent is isopropanol and/or a hydrotreated naphtha compound in mixture with IPA.

### Examples

### 1. Synthesis of a Thiol-PFPE Compound I.3 of Formula I According to the Invention:

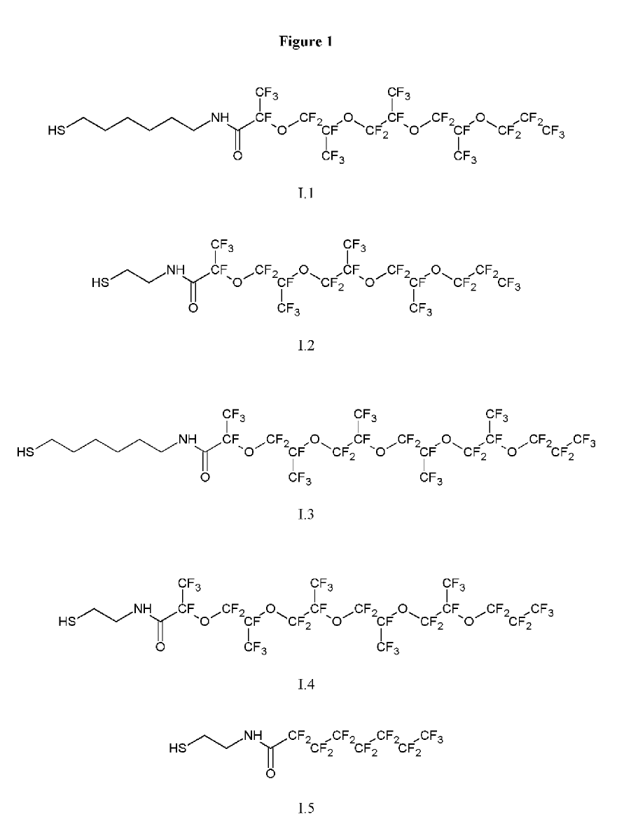

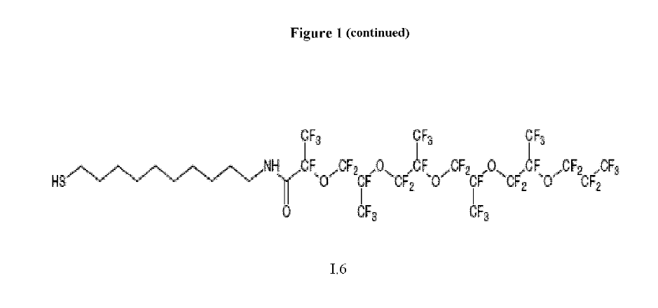

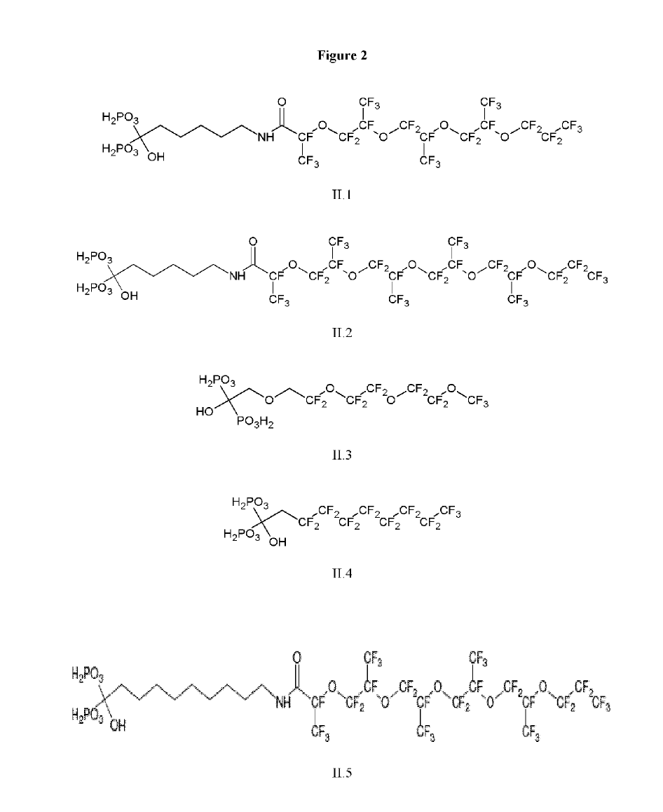

The compound I.3 (identified on FIG. 1) can be prepared in four steps following the synthesis plan presented below.

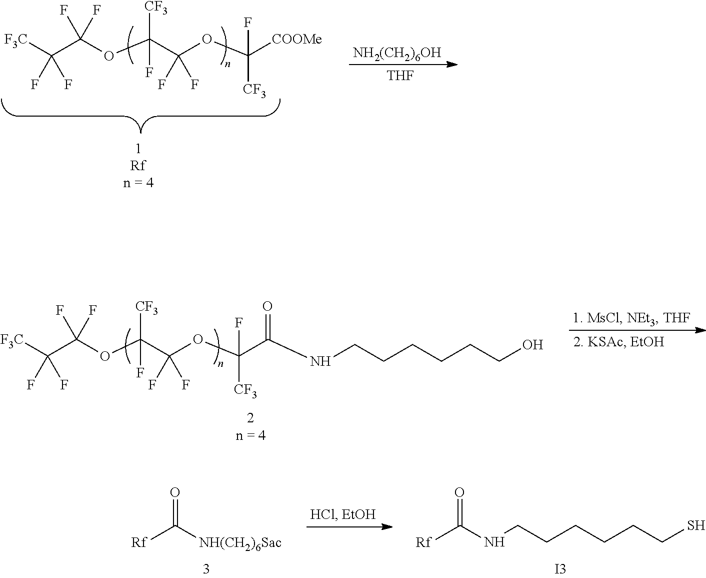

Preparation of Alcohol 2

6-aminohexan-1-ol (3.5 g; 29.7 mmol, 3 eq) was dissolved in 40 mL of THF under argon in a 100 mL triple-neck flask fitted with a condenser. Methyl ester 1 (10 g; 9.9 mmol) was added in a single addition. The biphasic mixture was heated at 50° C. until the perfluorinated derivative was completely dissolved (around 20 minutes) then stirred at room temperature under argon for 17 hours. After concentration on a rotary evaporator, the syrup obtained was taken up in AcOEt (120 mL) washed with a solution of 0.5 N hydrochloric acid solution (40 mL) then with distilled water (40 mL) and finally with brine (30 mL). The organic phase was dried (MgSO4), filtered then concentrated under vacuum (rotary evaporator then vane pump). Amide 2 is obtained in the form of a colourless oil.

Mass obtained: 10.3 g

Yield: 95%

¹H NMR (270 MHz acetone-d6) δ (ppm)=3.53 (t, 2H, CH2OH), 3.37 (m, 2H, CH2NH), 1.71-1.29 (m, 8H, 4 CH2).

13C NMR (acetone-d6) δ (ppm)=158.1 (d, J2C—F=24.9 Hz, CONH), 126.1-101.2 (m, CFs), 62.7 (CH2OH), 41.1 (CH2NH), 33.9, 29.8, 27.5, 26.5 (4 CH2).

Preparation of Thioacetate 3

Amide 2 (10.3 g, 9.4 mmol) placed in a 250 mL single neck flask was dissolved in 60 ml of THF under argon. Triethylamine (3.97 mL, 3 eq.) was added then methane sulphonyl chloride (1.46 mL, 2 eq.) while being cooled in an ice water bath. The suspension was stirred at room temperature under argon for 17 h. After concentration in the rotary evaporator, the mixture was taken up in AcOEt (120 mL) then washed in distilled water (50 mL) and finally in brine (40 mL). The organic phase was dried (MgSO4), filtered then concentrated under vacuum (rotary evaporator). The colourless oil obtained (mesylate) was dissolved in 150 mL of EtOH, potassium thioacetate KSAc (2.14 g, 2 eq.) was added to the solution then heated under argon at 60° C. for 2 h. After cooling down to room temperature, the mixture was concentrated in the rotary evaporator, the residue was taken up in AcOEt (120 mL) then washed with distilled water (2×50 mL) and finally in brine (40 mL). The organic phase was dried (MgSO4), filtered then concentrated under vacuum (rotary evaporator). The thioacetate 3 was obtained in the form of an orange oil.

Mass obtained: 9.5 g

Yield: 88%

¹H NMR (270 MHz acetone-d6) δ (ppm)=3.37 (m, 2H, CH2NH), 2.85 (t, 2H, CH2S), 2.28 (s, 3H, SAc), 1.75-1.29 (m, 8H, 4 CH2).

13C NMR (acetone-d6) δ (ppm)=195.4 (COCH3), 158.5 (d, J2C—F=24.9 Hz, CONH), 125.9-100.9 (m, CFs), 41.1 (CH2NH), 30.6, 29.6, 29.2, 27.1 (CH3, CH2).

Preparation of Thiol PFPE of Formula I.3

40 mL of concentrated HCl (10 N) was added to a solution of thioacetate 3 (9.5 g, 8.2 mmol) in 300 mL of EtOH. The red solution was heated to 90° C. for 2 h. After cooling to room temperature, the mixture was concentrated in a rotary evaporator, the residue was taken up in AcOEt (120 mL) then washed in distilled water (2×50 mL) and finally in brine (40 mL). The organic phase was dried (MgSO4), filtered then concentrated under vacuum (rotary evaporator). After drying in a vane pump (heating at 50° C.), thiol PFPE (13) was obtained in the form of an orange oil.

Mass obtained: 7.9 g

Yield: 86%

¹H NMR (270 MHz, acetone-d6) δ (ppm)=8.51 (s, 1H, CH₂NH), 3.38 (m, 2H, CH₂NH), 2.50 (t, 2H, CH₂S), 1.72-1.27 (m, 8H, 4 CH₂).

¹³C NMR (acetone-d6) δ (ppm)=158.5 (d, J²_{C.F}=24.9 Hz, CONH), 124.8-101.2 (m, CFs), 41.1 (CH₂NH), 35.1 (CH₂CH₂SH), 29.7, 28.9, 27.2 (3 CH₂), 25.0 (CH₂SH).

The other thiol-PFPE compounds are easily obtained according to a similar synthesis method using the following compounds:
Perfluororo-2,5,8,11-tetramethyl-3,6,9,12-methyl tetraoxapentadecanoate to obtain compound I.1.
Mercaptoethylamine and perfluororo-2,5,8,11-tetramethyl-3,6,9,12-methyl tetraoxapentadecanoate to obtain compound I.2.
Mercaptoethylamine and perfluororo-2,5,8,11,14-pentamethyl-3,6,9,12,15-methyl pentaoxaoctadecanoate to obtain compound I.4.
Mercaptoethylamine and methyl perfluoro-octanoate to obtain compound I.5
10-amino-decan-1-ol and perfluoro-2,5,8,11,14-pentamethyl-3,6,9,12,15-methyl pentaoxaoctadecanoate to obtain compound I.6.

### 2. Synthesis of a BP-PFPE Compound (for Example II.1) of Formula II According to the Invention:

The molecule II.1 can be prepared in four steps following the synthesis diagram below:

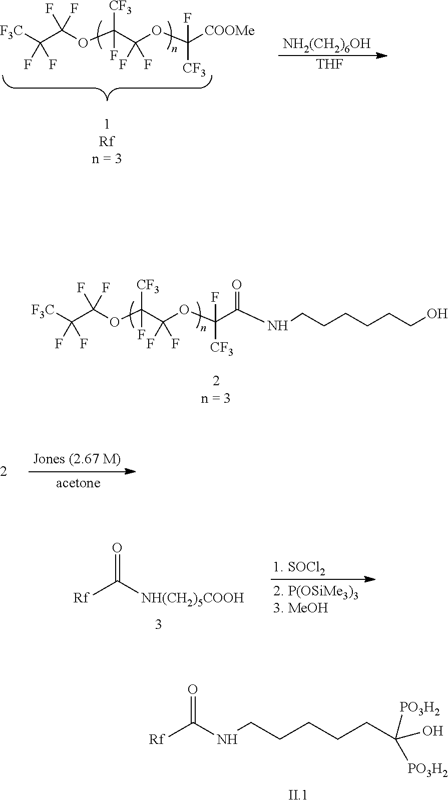

Firstly, 6-aminohexan-1-ol is acylated by the methyl ester PFPE 1 in THF at room temperature to produce the corresponding amide 2. The alcohol group is then oxidised into carboxylic acid 3 through the action of Jones reagent. Finally compound 3 is transformed into bisphosphonic acid II.1 via an acid chloride.

The operating method is described below:
Dissolve 6-aminohexanol (1.25 g; 10.7 mmol) in 15 mL of anhydrous THF in a 50 mL single-neck flask under argon. The methyl ester 1 (3 g; 3.56 mmol) was added in one addition. The biphasic mixture which becomes homogeneous and clear after a few minutes was stirred at room temperature for 17 hours. After concentration in the rotary evaporator, the syrup obtained was taken up in AcOEt (25 mL), washed with a 1N hydrochloric acid solution then with water. The organic phase was dried (MgSO₄), filtered then concentrated under vacuum (rotary evaporator then vane pump). The colourless molecule 2 oil was obtained.
The alcohol 2 (3.1 g, 3.3 mmol) was dissolved in 40 mL of acetone. A 2.67 M solution of Jones reagent was added drop by drop. After 15 minutes of stirring at room temperature, a few drops of isopropanol were added, then the mixture was filtered, concentrated, taken up in AcOEt and washed twice with water. The organic phase was dried, filtered then concentrated under vacuum (rotary evaporator then vane pump). Carboxylic acid 3 was obtained in the form of a colourless oil.
Carboxylic acid 3 (3.1 g; 3.3 mmol) was mixed under argon with 8 mL of thionyl chloride. The mixture was then heated under reflux for 45 minutes then concentrated under vacuum. The syrup obtained was placed under argon then P(OSiMe₃)₃ was added (2.5 eq., 2.75 mL). The solution was stirred under argon for 2 h, concentrated under vacuum then 10 mL of methanol was added. After 1 h of stirring, the mixture was concentrated. The syrup obtained was washed with water. The molecule II.1 was then dried on the vane pump.

The other components of BP-PFPE are easily obtained according to a similar synthesis method, using the following compounds:
Perfluoro-2,5,8,11,14-pentamethyl-3,6,9,12,15-methyl pentaoxaoctadecanoate to obtain the compound 11.2.
1H,1H-perfluoro-3,6,9-trioxadecan-1-ol to obtain the compound II.3.
1H,1H,2H,2H-perfluorodecan-1-ol to obtain the compound II.4.
10-amino-decan-1-ol and perfluoro-2,5,8,11,14-pentamethyl-3,6,9,12,15-methyl pentaoxaoctadecanoate to obtain the compound II.5.

### 3. Example of the Deposit Method According to the Invention:

Preparation of the BP/Thiol-PFPE Mixture Solution

To prepare 50 mL of the mixture according to the invention:
a) Weigh 1.09 g of compound BP-PFPE of formula II.1 and dissolve it in 25 mL of isopropyl alcohol (IPA).
b) Weigh 1.11 g of compound thiol-PFPE of formula I.3 and dissolve in 25 mL of IPA.
c) Mix the previous 2 solutions in an Erlenmeyer flask for 30 min, filter the mixture on filter paper if a slight precipitate is formed. Pour the mixture into a Nalgene type bottle and store at room temperature away from light.
d) Dilute to one twentieth in IPA.

Preparation of Materials

Degrease the parts by washing in a solvent (acetone or IPA) under ultrasound for 5 minutes then dry the parts under a stream of hot air.

In the case of silicon, oxidation of the material is recommended to promote grafting. This oxidation is carried out as follows:
1. The silicon part is immersed in a Piranha solution (conc H₂SO₄/H₂O₂ at 30% 3:1) freshly prepared for 45 min.
2. The part is rinsed 3 times in deionised water.
3. The part is dried for 10 minutes in an oven at 80° C.

Deposit
Place the part or parts in a container with an adapted shape
Cover the part or parts with coating solution (thiol, BP or BP/thiol-PFPE mixture),
Incubate between 5 minutes and 360 minutes,
Eliminate the supernatant—remove the part,
The part is drip dried (centrifugation).

Dehydration—Rinsing
The part which received the deposit is placed in an oven at 120° C. for a period ranging from 6 to 15 h (only for rubies and silicon),
The part is brought back to room temperature then immersed in IPA under ultrasound for 2 minutes,
The part is dried under a stream of hot air.

The “deposit” and the “dehydration-rinsing” steps can be repeated.

### 4. Solubility of the Thiol-PF and BP-PF Compounds of the Invention

4.1. The Solubility of Perfluorinated Thiol Molecules, Perfluoro-BP Molecules and Mixtures Consisting of these Two Categories of Molecules were Analysed in Four Solvents:
1) 3-methoxy-methylbutan-3-ol (MMB),
2) Acetone (ACE),
3) Isopropanol (IPA) and
4) The solvent Biosane T212 of brand MMCC (T212) which consists of hydrotreated naphthas.

The advantage of the latter solvent is that it is very volatile and hardly flammable.

The solubilisation of molecules was carried out in the usage concentrations, that is between 10⁻³ and 10⁻⁵ M.

The method employed to test dissolution was the following:
For study solvents (MMB, ACE and IPA), the compounds were individually diluted in the solvent with magnetic stirring at room temperature to obtain a final solution with concentrations ranging between 10⁻³ and 10⁻⁵ M,
For solvent T212, the compounds were initially dissolved in isopropanol (IPA) under magnetic stirring and at room temperature to obtain solution S. This solution S was then diluted to 5% in the solvent so as to obtain a final solution with concentrations ranging between 10⁻³ and 10⁻⁵ M.

For each of these tests, the molecules were considered to be dissolved when the solution showed no cloudiness. The results of the test are as follows:
All the molecules developed are independently soluble in solvent T212 as well as in IPA;
The majority of perfluorinated thiols and perfluoro-BP molecules are soluble in all the studied solvents;
Molecule I.4 is weakly soluble in MMB and ACE.

### 4.2 Solubility of BP-PF and Thiol-PF Compounds in the Composition of the Invention.

The solubility of the thiol-bisphosphonate mixture may be modified as a function of the length of molecule chains, their respective concentrations and the type of solvent used. All the mixtures are soluble in IPA.

### 5. Lipophobic Effect of the Composition of the Invention

### 5.1. Deposit Protocol

Different surfaces were treated with solutions of thiol I.3 and BP II.1 molecules. The solutions were freshly prepared. The tests were carried out with solutions containing 10⁻³ M of each of the molecules dissolved in IPA. The final solution was then deposited on gold, rubies, steel 20 AP, and on NiP and SnNi alloys. The soaking time was 30 minutes, the rinsing time was 2 minutes.

The lipophobic effect was evaluated by measuring the contact angles of a test oil having surface tension of 33 mN/m on different surfaces. All the surfaces showed a substantial lipophobic and hydrophobic effect.

### 5.2. Hydrophobic and Lipophobic Effect on Different Materials

### Demonstration of the Effect of the Hydrophobic and Lipophobic Effect by Measurement of Contact Angles.

According to the deposit procedure described in paragraph 3, the materials were treated by the mixture of the thiol molecule I.3. with the BP molecule II.1. dissolved in IPA. The contact angles were measured before and after treatment of the surface.

The results before and after treatment are presented in the two tables below:

TABLE 1
contact angles on materials before treatment

| | Au | Rubies | Steel | NiP | SnNi |
|---|---|---|---|---|---|
| H₂O | 99.6° ± 2.1 | 49.7° ± 7.2° | 97.1° ± 0.9° | 96.8° ± 2.0° | 98.3° ± |
| | | | | | 1.4° |
| Test | 15.3° ± 2.7° | 24.7° ± 2.0° | 19.5° ± 3.7° | 25.6° ± 2.7° | 35.1° ± |
| oil | | | | | 6.5° |

TABLE 2
contact angles on materials after treatment

| | Au | Rubies | Steel | NiP | SnNi |
|---|---|---|---|---|---|
| H₂O | 111.8° ± 2.2 | 105.0° ± 5.2° | 101.7° ± 2.3° | 110.6° ± | 107.1° ± |
| | | | | 5.2° | 3.0° |
| Test | 61.5° ± 3.5° | 63.6° ± 1.9° | 61.0° ± 5.0° | 68.3° ± | 65.5° ± |
| oil | | | | 3.9° | 3.2° |

### Demonstration of the Lipophobic and Hydrophobic Effect by Measurement of Surface Energies

The contact angles measured from drops of water, glycerol and diiodomethane on different materials before and after treatment made it possible to calculate the surface energies according to the Owens Wendt method.

TABLE 3
surface energies of materials before treatment

| | Au | Rubies | Steel | NiP | SnNi |
|---|---|---|---|---|---|
| Surface energy (mJ/m²) | 36.0 | 52.6 | 34.1 | 39.3 | 34.3 |
| Dispersive component | 34.5 | 25.7 | 30.7 | 37.4 | 31.5 |
| Polar component | 1.5 | 27.0 | 3.4 | 1.9 | 2.8 |

TABLE 4
surface energies of materials after treatment

| | Au | Rubies | Steel | NiP | SnNi |
|---|---|---|---|---|---|
| Surface energy (mJ/m²) | 15.1 | 18.0 | 19.5 | 13.0 | 19.6 |
| Dispersive component | 13.7 | 16.0 | 18.5 | 12.2 | 18.1 |
| Polar component | 1.4 | 2.0 | 1.0 | 0.7 | 1.4 |

### 5.3. Effect of Coating Time

The two compounds of the invention I.1 and II.1 were mixed either at 10⁻³M or at 10⁻⁴M in IPA and contact with gold lasted 0, 10, 30, 60 or 360 minutes.

With regard to the results presented in the table below, it appears that a coating step lasting 10 minutes is sufficient for the surface to be well functionalised. This time is therefore considered to be advantageous for carrying out the method of the invention.

TABLE 5
contact angles of the test oil with parts treated by means of a
solution according to the invention (containing
10⁻³M of compound I.1 and 10⁻³M of compound II.1
or 10⁻⁴M of compound I.1 and 10⁻⁴M of compound
II.1) as a function of coating time (0, 10, 30, 60 and 360 minutes).

| Time | | | | | |
|---|---|---|---|---|---|
| (min) | 0 | 10 | 30 | 60 | 360 |
| 10⁻³M | 25.6 ± 2.7° | 50.4 ± 8.8° | 60.8 ± 5.8° | 63.2 ± 3.7° | 76.4 ± 0.6° |
| 10⁻⁴M | 25.6 ± 2.7° | 36.6 ± 11.1° | 54.4 ± 4.7° | 55.7 ± 7.7° | 68.9 ± 2.5° |

### 6. Effect of the Concentration of the Compound of Formula I and II

In order to evaluate the lipophobic and hydrophobic properties of thiol/BP mixtures, coating of different materials by soaking these molecules in solution in IPA for 30 minutes followed by rinsing with IPA for 2 minutes under ultrasound (US) was carried out.

The following mixtures were tested:

| Mixture No | Thiol PFPE (I.3) | Bisphosphonate PFPE (II.1) |
|---|---|---|
| 1 | 10⁻³M | 10⁻³M |
| 2 | 10⁻⁴M | 10⁻³M |
| 3 | 10⁻³M | 10⁻⁴M |

Molecule I.3 was selected for continuation of the study given that the contact angles obtained for this molecule were the highest. Nevertheless, the other molecules also result in functional layers with a satisfactory lipophobic and hydrophobic effect.

The results obtained are given in the form of a contact angle of a drop of water, respectively a drop of test oil on different materials.

TABLE 6
contact angles of water drops, the test oil respectively with parts
made of gold-plated brass (Au), rubies, steel 20 AP, NiP and on
SnNi coating as a function of soaking time in the solution according
to the invention (mixture of compounds I.3 and II.1 at 10⁻³M).

| Time | Liquid | Au | Rubies | Steel | NiP | SnNi |
|---|---|---|---|---|---|---|
| 0 min | H₂O | 99.6 ± 2.1° | 49.7 ± 7.2° | 97.1 ± 0.9° | 96.8 ± 2.0° | 98.3 ± 1.4° |
| 0 min | Test oil | 25.6 ± 2.7° | 24.7 ± 2.0° | 19.5 ± 3.7° | 15.3 ± 2.7° | 35.1 ± 6.5° |
| 5 min | H₂O | 115.5 ± 1.7° | 106.4 ± 1.7° | 102.3 ± 2.5° | 112.4 ± 2.3° | 104.7 ± 3.6° |
| 5 min | Test oil | 68.9 ± 3.5° | 72.5 ± 7.5° | 58.5 ± 7.1° | 70.7 ± 5.3° | 63.9 ± 2.9° |
| 10 min | H₂O | 117.0 ± 2.8° | 108.0 ± 1.4° | 103.2 ± 1.6° | 114.0 ± 1.4° | 104.8 ± 1.2° |
| 10 min | Test oil | 68.6 ± 4.1° | 70.3 ± 3.3° | 63.3 ± 2.6° | 75.5 ± 3.1° | 62.6 ± 4.1° |
| 30 min | H₂O | 112.3 ± 3.6° | 105.7 ± 4.7° | 110.8 ± 0.3° | 103.9 ± 1.0° | 108.1 ± 4.0° |
| 30 min | Test oil | 65.6 ± 1.9° | 71.8 ± 1.4° | 68.3 ± 5.6° | 73.1 ± 6.4° | 73.6 ± 4.6° |

From table 6, it would appear that the test solution gives better results than mixture no. 1, comprising a mixture of 50% molecule I.3 (at 10⁻³ M) and 50% bisphosphonate II.1 (at 10⁻³ M).

The proportion of each of the molecules in the mixture has a particular effect on the quality of surface treatment but all the mixtures and the different thiol and BP molecules tested led to a self-assembled layer with the required oleophobic properties for anti-fingerprints, anti-adhesion and anti-contamination applications.

It is also possible to carry out several successive deposits on the same compound with an intermediate rinsing.

### 7. Resistance to Washing

The resistance of the layers of the invention was evaluated after one or several washing cycles by measuring the contact angle with H₂O and the test oil. Good hold on the various materials evaluated was observed, even after several washing cycles.

Moreover, the resistance to washing with products based on highly alkaline detergents such as “Rubisol” for gold was tested and showed that the lipophobic and hydrophobic properties on gold resist Rubisol washing well (angle >30°).

### 8. Lipophobic and Hydrophobic Effect on Different PF Thiol I.1-I.5 Molecules Only

On the basis of the kinetics of molecule I.1, the following parameters were used to test the four other thiol-PF and thiol-PFPE molecules (I.2, I.3, I.4, I.5):
Concentration: 10⁻³M for each compound I.1 to I.5
Solvent: Isopropyl alcohol (IPA) or Biosane T212 (MMCC)
Soaking Time: 30 minutes
Rinsing time: 2 minutes under ultrasound
Drying: hot air

Evaluation of functional properties was carried out by measuring the contact angles between the surface of the metal and the drop of oil. The results are presented in the table below. It is noticeable that the concentration of 10⁻³M gives an angle of over 45° for all molecules I.1 to I.5.

TABLE 7
contact angle of the gold-plated brass part with the test oil as a function of
solvent (MMCC or IPA) and the coating molecule I.1-I.5 used at 10⁻³M.

| | IPA | MMCC |
|---|---|---|
| Reference | 25.6 ± 2.7° | |
| I.1 | 60.8 ± 5.8° | 64.5 ± 2.9° |
| I.2 | 48.5 ± 4.3° | 72.6 ± 1.6° |
| I.3 | 75.7 ± 6° | 63.8 ± 2.8° |
| I.4 | 69.9 ± 2.9° | 68.9 ± 2.5° |
| I.5 | 67.6 ± 3.6° | 49.5 ± 2.5° |

The different molecules moreover show good resistance to Rubisol type washing when the layer is made up of a solution of concentration 10⁻³M of I.1 to I.5.

The effect of molecule I.3 is significantly greater than that of the untreated reference surface (Student test, p<0.02).

The better efficacy of molecule I.3 is a combination of its solubility, its hydrophobic and lipophobic efficacy and its resistance to washing.

9. Hydrophobic and Lipophobic Effect of Thiol and Bisphosphonate Molecules and their Mixtures

The lipophobic/hydrophobic effect of thiol and bisphosphonate molecules was tested for each molecule alone, then for their mixtures in order to detect any synergetic effect produced by a combination of two types of molecule.

The following thiol molecules were tested:

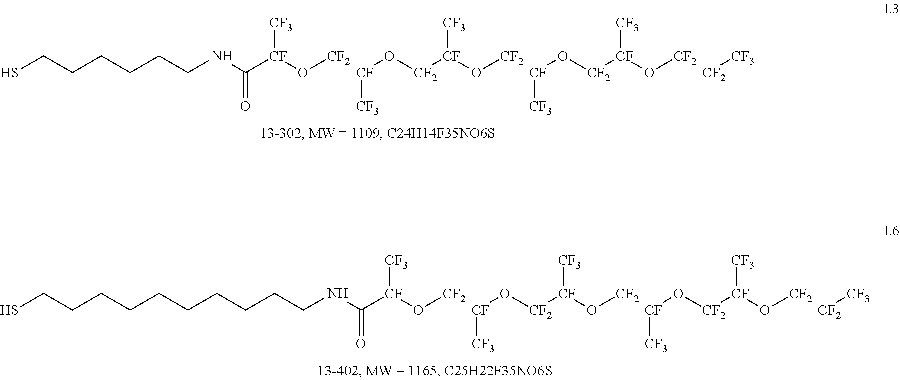

Molecule I.3 corresponds to the molecule studied in examples 1 and 3 above. Molecule 13-402 (I.6.) has a longer aliphatic group.

The following bisphosphonate molecules were tested:

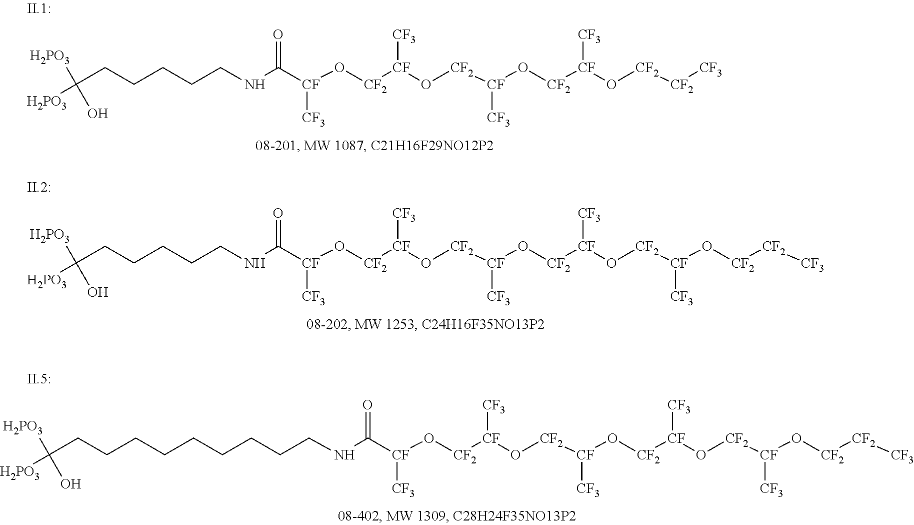

All the molecules were synthesised in quantities in the order of a gram with satisfactory yield. The purity of each compound is greater than 90%.

### Properties of Thiol and Bisphosphonate Molecules Alone

The properties of thiol and bisphosphonate molecules in isolation were measured on the surfaces of steel and gold-plated substrates using solutions at 10⁻³ M and in isopropanol in accordance with the protocol described in example 3 above, with a soaking time of 5 minutes. The results obtained are as follows:

TABLE 8
contact angle of the gold-plated brass and steel
parts with water and with the test oil for
coating molecules used at 10⁻³M in IPA.

| | Au | Au | Steel | Steel |
|---|---|---|---|---|
| Molecule | H₂O | Test oil | H₂O | Test oil |
| II.1 BP | 101.3 | 51.7 | 98.6 | 47.3 |
| II.2 BP | 109.4 | 66.2 | 105.1 | 61.7 |
| I.3 thiol | 96.4 | 69.0 | 70.2 | 33.5 |
| I.6 thiol | 97.9 | 71.0 | 74.1 | 34.4 |

The standard deviation for three measurements is between 1° and 5°. It is noted that the two types of molecule allow valid functionalisation of gold plated substrate but that thiols alone do not bind (or bind very little) to steel.

### Combination of Thiol and Bisphosphonate Molecules

Six mixtures were tested. For mixture 1 (I.3/II.1), it is necessary to refer to example 6 above.

TABLE 9
Treatment solutions according to the invention tested within the scope of
example 9 (mixture of thiol compounds I.3 and I.6 with bisphosphonate
compounds II.1, II.2 and II.5 at 10⁻³M and 10⁻⁴M in IPA).

| Molecule | II.1 | II.2 | II.5 |
|---|---|---|---|
| I.3 | Mixture 1 | Mixture 4 | Mixture 5 |
| I.6 | Mixture 6 | Mixture 7 | Mixture 8 |

Solubility was qualified by observing the clarity of solutions on mixing with isopropanol, after 1 h and 24 h. The concentrations tested are 10⁻³M and 10⁻⁴ M for each of the molecules. In all these configurations, no loss of solubility was noted.

The following table gives the results obtained:

TABLE 10
contact angle of water drops, test oil respectively with gold-plated
brass, steel and ruby partscoated by soaking in a treatment
solution according to the invention (mixtures 1 and 4 to 8,
according to table 9, at 10⁻³M in IPA)

| Mixture of | Au | Au | Steel | Steel | Ruby | Ruby |
|---|---|---|---|---|---|---|
| molecules | H₂O | Test oil | H₂O | Test oil | H₂O | Test oil |
| Mixture 1 | 112 | 64 | 103 | 68 | 105 | 64 |
| Mixture 4 | 111 | 68 | 106 | 73 | 106 | 76 |
| Mixture 5 | 111 | 82 | 110 | 74 | 112 | 71 |
| Mixture 6 | 101 | 80 | 104 | 45 | 114 | 69 |
| Mixture 7 | 112 | 81 | 107 | 69 | 113 | 71 |
| Mixture 8 | 112 | 79 | 109 | 70 | 114 | 76 |

Firstly, we find that lipophobic/hydrophobic functionality is good for all mixtures, with a contact angle that is always greater than 60° with the test oil and always greater than 100° with water.

There is no important effect of concentration on the hydrophobic and oleophobic properties even though results are generally better at a concentration of 10⁻³ M.

Comparison of the results obtained with the mixtures and the molecules alone makes it possible to identify the following teachings: on gold-plated surfaces, the measured contact angles are similar for the molecules alone and for the mixtures. On the other hand, the use of a mixture significantly improves hold over time, and in particular resistance to washing compared to the molecule alone. This may be explained by the fact that gold is a noble metal with no oxide group at the surface, which means that the BP hook has little possibility of attaching permanently to the surface. It should also be noted that a mixture leads to better resistance to washing than the thiol molecule alone, and that the combination of two molecules gives an unexpected effect. For steel, the contact angles after depositing are lower for the molecules alone than for mixtures. In addition, the mixtures have much better resistance to washing than the molecules used alone.

The results obtained for mixtures of molecules are better than when the molecules are used alone. The mixtures of these two classes of molecules are therefore clearly more advantageous than the same molecules used alone, even for surfaces where one of the molecules is meant to have a negligible effect (for example, Au for BP molecules), indicating an unexpected synergetic effect.

This synergetic effect between thiol and bisphosphonate molecules promotes their adhesion to materials when they are in mixture. It may also be explained by an arrangement between the different chemical groups of these molecules which results in reactive groups being preferentially presented at the surface of the material.

### BIBLIOGRAPHY

Lecollinet G. et al., Langmuir, 2009, 25 (14), pp 7828-7835.
Bonard J.-M., Actes du Congrès International de Chronométrie 2004, p. 131, 2004
Bain C. D. et al, J. Am. Chem. Soc, 111(1), 321-335, 1989
Colorado R. et al, Langmuir 2003, 19 (8), 3288-3296
Folkers et al., Langmuir, (1995) 11, 813-824
Fukushima H. et al, J. of Phys Chem b 2000, 104, (31), 7417-7423
Massin M, Actes du congrès des Sociétés Allemande et Française de Chronométrie, p. 95 (1971).
Osowiecki M., Bulletin de la Société Suisse de Chronométrie SSC III, p. 735 (1957).
Renaud P. et al., Bulletin de la Société Suisse de Chronométrie III, p. 681 (1956)
Shi C. et al., J. Supercriti. Fluids 2000, 17, 81-90
Saunders et al, J. Phys Chem B 2004, 108, (41), 15969-15975

1. Composition comprising at least one thiol compound and at least one bisphosphonic compound or a salt thereof, said thiol compound having the formula:
HS-A-B-C
wherein
A is a (CH₂)ₘ—X— group, m being an integer between 0 and 100, and X being a saturated or unsaturated C₀-C₁₀₀ alkyl group, perfluorinated or partially fluorinated, the alkyl chain optionally being substituted or interrupted by 0 to 10 cycloalkyl or aryl groups that may be perfluorinated or not;
B is
a) a single chemical bond, or an O, S atom or an S(CO),(CO)S or NR, (CO)NR, NR(CO) group, R being a hydrogen atom or a C₁-C₁₀ alkyl, or 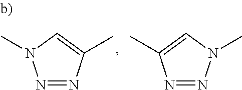
and
C is chosen from among: F(CF(CF₃)CF₂O)ₙCF(CF₃)—,
F(CF₂CF(CF₃)O)ₙCF₂CF₂—, F(CF₂CF₂CF₂O)ₙCF₂CF₂—, and F(CF₂CF₂O)ₙCF₂—, and CₚF₂ₚ₊₁—, wherein n and p are integers between 1 and 100,
and said bisphosphonic compound having the formula: 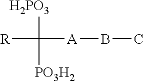
wherein
R is a hydrogen atom H or OH group,
A is a (CH₂)ₘ—X group, m being an integer between 0 and 100, and X being a saturated or unsaturated C₀-C₁₀₀ alkyl group, perfluorinated or partially fluorinated, the alkyl chain possibly being substituted or interrupted by 0 to 10 cycloalkyl or aryl groups that may be perfluorinated or not;
B is
a) a single chemical bond, or an O, S atom or an S(CO),(CO)S or NR, (CO)NR, NR(CO) group, R being a hydrogen atom or C₁-C₁₀ alkyl, or 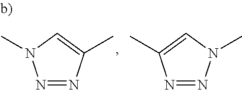
and
C is chosen from among: (CF(CF₃)CF₂O)ₙCF(CF₃)—,
F(CF₂CF(CF₃)O)ₙCF₂CF₂—, F(CF₂CF₂CF₂O)ₙCF₂CF₂—, F(CF₂CF₂O)ₙCF₂ and CₚF₂ₚ₊₁—, wherein n and p are integers between 1 and 100.

2. Composition according to claim 1 wherein said thiol compound is a perfluorinated thiol of the following formula I: 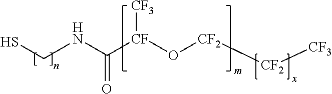
wherein n is an integer from 1 to 100, m is an integer from 1 to 100 and x is an integer between 1 and 10.

3. Composition according to claim 1 wherein said bisphosphonic compound is a perfluorinated bisphosphonic of the following formula II: 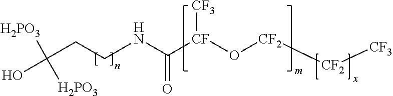
wherein n is an integer between 1 and 100, m is an integer between 1 and 100, and x is an integer between 1 and 10.

4. Composition according to claim 2 wherein said perfluorinated thiol compound is a compound of formula I wherein n=6, m=4, and x=1, or n=2, m=4 and x=1, or n=10, m=5, and x=1, or n=6, m=5 and x=1, or n=2, m=5, and said bisphosphonic compound is a perfluorinated bisphosphonic compound of formula II 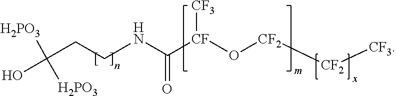
wherein n=4, m=4 and x=1 or n=8, m=5, and x=1.

5. Composition according to claim 1 wherein said bisphosphonic and thiol compounds are dissolved in an organic solvent chosen from alcohol solvents, aldehydes, ketones, ethers or alkanes, as well as mixtures thereof, or in a solvent consisting of hydrotreated naphthas mixed with isopropanol or acetone.

6. A method for increasing the hydrophobicity and/or the lipophobicity of a metal surface which comprises applying the composition of claim 1 to the metal surface.

7. A method for limiting the corrosion of a metal surface which comprises applying the composition of claim 1 to the metal surface.

8. A method for limiting dirt deposits and/or microbial contamination of a metal surface which comprises applying the composition of claim 1 to the metal surface.

9. A method for lubricating a metal surface which comprises applying the composition of claim 1 to the metal surface.

10. The method of claim 6 wherein said metal surface consists of over 50% of:
noble metals selected from gold, platinum, silver and copper,
oxidised metals selected among iron, titanium, aluminium, ruby, sapphire, nickel, ruthenium, rhodium and tin,
alloys selected from steel, stainless steel, brass, nickel-silver, bronze, tin-nickel, nickel-phosphorus, copper-beryllium, palladium-nickel, copper-cobalt, or alloys containing vanadium, chromium, manganese, zinc, tungsten or zirconium, or another amorphous alloys,
ceramics,
semi-conductors containing silicon or germanium and oxides thereof, or diamond.

11. Method for coating a metal surface with a molecular functionalisation layer, which comprises the following steps:
a) optionally degreasing the surface by washing with a solvent and then drying,
b) optionally oxidising the surface so as to create hydroxyl groups at the surface of the substrate,
c) contacting the surface with a composition defined in claim 1, up to the point of self-assembly of thiol and/or bisphosphonic compounds in a single layer coating said surface,
d) removing the supernatant,
e) optionally dehydrating the surface thus coated,
f) rinsing the functionalised surface, and
g) drying the functionalised surface.

12. Method according to claim 11 wherein said surface is composed of more than 50%:
noble metals selected from gold, platinum, silver and copper,
oxidised metals selected from iron, titanium, aluminium, ruby, sapphire, nickel, ruthenium, rhodium and tin,
alloys selected from steel, stainless steel, brass, nickel-silver, bronze, tin-nickel, nickel-phosphorus, copper-beryllium, palladium-nickel, copper-cobalt, or alloys comprising vanadium, chromium, manganese, zinc, tungsten, or zirconium, or another amorphous alloy,
ceramics,
semi-conductors containing silicon or germanium as well as oxides thereof, or diamond.

13. A method for manufacturing bottles and/or stoppers intended for pharmaceuticals, cosmetics, or perfumes, luxury goods micromechanical parts or microelectronic parts, which comprises conducting the method of claim 11 to coat the surface of the bottle, stopper, luxury good, micromechanical part or microelectronic part.

14. Composition according to claim 1 wherein said bisphosphonic and thiol compounds are dissolved in an organic solvent chose from isopropanol, ethanol, methanol, acetone, diethyl ether, or tetrahydrofuran.

15. The method of claim 7 wherein said metal surface consists of over 50% of:
noble metals selected from gold, platinum, silver and copper,
oxidised metals selected among iron, titanium, aluminium, ruby, sapphire, nickel, ruthenium, rhodium and tin,
alloys selected from steel, stainless steel, brass, nickel-silver, bronze, tin-nickel, nickel-phosphorus, copper-beryllium, palladium-nickel, copper-cobalt, or alloys containing vanadium, chromium, manganese, zinc, tungsten or zirconium, or another amorphous alloys,
ceramics,
semi-conductors containing silicon or germanium and oxides thereof, or diamond.

16. The method of claim 8 wherein said metal surface consists of over 50% of:
noble metals selected from gold, platinum, silver and copper,
oxidised metals selected among iron, titanium, aluminium, ruby, sapphire, nickel, ruthenium, rhodium and tin,
alloys selected from steel, stainless steel, brass, nickel-silver, bronze, tin-nickel, nickel-phosphorus, copper-beryllium, palladium-nickel, copper-cobalt, or alloys containing vanadium, chromium, manganese, zinc, tungsten or zirconium, or another amorphous alloys,
ceramics,
semi-conductors containing silicon or germanium and oxides thereof, or diamond.

17. The method of claim 9 wherein said metal surface consists of over 50% of:
noble metals selected from gold, platinum, silver and copper,
oxidised metals selected among iron, titanium, aluminium, ruby, sapphire, nickel, ruthenium, rhodium and tin,
alloys selected from steel, stainless steel, brass, nickel-silver, bronze, tin-nickel, nickel-phosphorus, copper-beryllium, palladium-nickel, copper-cobalt, or alloys containing vanadium, chromium, manganese, zinc, tungsten or zirconium, or another amorphous alloys,
ceramics,
semi-conductors containing silicon or germanium and oxides thereof, or diamond.
